(19) United States
(12) Patent Application Publication
(10) Pub. No.: US 2012/0101197 A1
(43) Pub. Date: Apr. 26, 2012

(54) POLYMER COMPOSITION CONTAINING POLYBUTYLENE TEREPHTHALATE AND FLAME RETARDANT ADDITIVES

(76) Inventors: Jeroen J. Crevcoeur, Maastricht (NL); Theodorus Johannes Gerardus Zwartkruis, Sittard (NL)

(21) Appl. No.: 13/202,167

(22) PCT Filed: Mar. 24, 2010
(86) PCT No.: PCT/EP2010/053804

§ 371 Date: Dec. 5, 2011

(30) Foreign Application Priority Data
Mar. 31, 2009 (EP) 09156825.3

(51) Int. Cl. C08K 5/3492

(52) U.S. Cl. 524/101

(57) ABSTRACT

Polymer composition containing: as the polymeric constituents A. 90-50 wt. % polybutylene terephthalate (PBT) B. 10-50 wt. % polyethylene terephthalate (PET), the polymeric constituents add up to 100 wt. %, at 100 part by weight of the sum of the polymeric constituents: C. 10-40 part by weight of metal salts of phosphinic acids and/or diphosphinic acids or polymeric derivatives thereof. D. 3-30 part by weight of a nitrogen or nitrogen and phosphor containing flame retardant synergist for metal salts of phosphinic acids and/or diphosphinic acids or polymeric derivatives thereof, E. 0-80 part of glass fibers.

The invention relates to a polymer composition containing polybutylene terephthalate and flame retardant additives. Such polymer compositions are frequently used in parts for electrical and electronic equipment, for example in connectors, housings of relays and bobbins, lamp sockets etc.

It is important for such compositions to have a high level of flame-retardancy, while maintaining their further properties at an acceptable level. Another important demand in the last years, due to increased attention to environmental problems, is the use of halogen free flame retardants. This puts restrictions on the freedom to formulate new compositions and makes it therefore difficult to develop further improved compositions.

From WO 99/02606 a halogen free flame retardant polymer composition is known containing a thermoplastic polyester, for example polybutylene terephthalate, an organic phosphorous compound and a compound derived from triazine. The composition of WO 99/02606 shows a high level of flame retardancy at a moderate level of flame retardants in the composition. However there still exists a need for a further improved composition. Object of the invention is to provide such a further improved composition.

Surprisingly this object is obtained by a polymer composition containing:
as the polymeric constituents
A. 90-50 wt. % polybutylene terephthalate (PBT)
B. 10-50 wt. % polyethylene terephthalate (PET),
the polymeric constituents add up to 100%,
at 100 part by weight of the sum of the polymeric constituents:
C. 10-40 parts by weight of metal salts of phosphinic acids and/or diphosphinic acids or polymeric derivatives thereof.
D. 3-30 parts by weight of a nitrogen or nitrogen and phosphor containing flame retardant synergist for metal salts of phosphinic acids and/or diphosphinic acids or polymeric derivatives thereof.
E. 0-80 parts of glass fibers.

Surprisingly this composition shows a high level of flame retardancy. It is even possible to produce objects with a low wall thickness from the composition that shows an UL VO classification, which indicates a high level of flame retardancy. The compositions according to the invention especially show short burning times at low wall thicknesses. Furthermore the surface of objects made from the composition show a relatively high level of gloss.

Preferably a composition according to the invention is provided having a burning time of less than 25 sec., more preferably less than 22 sec. measured at a sample of 0.4 mm thickness, preferably of 0.3 mm thickness.

### A. PBT

Polybutylene terephthalate (PBT) may be produced from the polycondensation reaction of butane diol and terephthalic acid and/or the methyl ester of terephthalic acid.

### B. PET

Polyethylene terephthalate PET may be produced from the polycondensation reaction of ethylene diol and terephthalic acid and/or the methyl ester of terephthalic acid. PBT and PET may comprise minor amounts, for example up to 5 wt. % of further monomer units, for example monomeric units of further alkylene diols and aromatic dicarboxylic acids.

Preferably the composition contains 80-52 wt. PBT and 20-48 wt. % PET, more preferably the composition contains 70-54 wt. % of PBT and 30-46 wt. % of PET, this all under the condition that A and B up to 100 wt. %. This means that the polymer composition contains only PET and PBT as the polymeric constituents and the composition does not contain any further polymer.

### C. Metal Phosphinates

The component C in the flame retardant elastomeric composition consists of metal salts of phosphinic acids and/or diphosphinic acids or polymeric derivatives thereof, which compounds are also denoted as metal phosphinates. This term will also be used further herein to indicate the same compounds.

Suitably, the metal phosphinate is a metal of a phosphinic acid of the formula [R¹R²P(O)O]⁻ₘM^{m+} (formula I) and/or a diphosphinic acid of the formula [O(O)PR¹—R³—PR²(O)O]²⁻ₙMₓ^{m+} (formula II), and/or a polymer thereof, wherein
R¹ and R² are equal or different substituents chosen from the group consisting of hydrogen, linear, branched and cyclic C1-C6 aliphatic groups, and aromatic groups,
R³ is chosen from the group consisting of linear, branched and cyclic C1-C10 aliphatic groups and C6-C10 aromatic and aliphatic-aromatic groups,
M is a metal chosen from the group consisting of Mg, Ca, Al, Sb, Sn, Ge, Ti, Zn, Fe, Zr, Ce, Bi, Sr, Mn, Li, Na, and K, and
m, n and x are equal or different integers in the range of 1-4.

Suitable metal phosphinates that can be used as component C in the present invention are described for example in DE-A 2 252 258, DE-A 2 447 727, PCT/W-097/39053 and EP-0932643-B1. Preferred phosphinates are aluminium-, calcium- and zinc-phosphinates, i.e. metal phosphinates wherein the metal M=Al, Ca, Zn respectively, and combinations thereof. Also preferred are metal phosphinates wherein R¹ and R² are the same or different and are equal to H, linear or branched C₁-C₆-alkyl groups, and/or phenyl. Particular preferably, R¹, R² are the same or different and are chosen from the group consisting of hydrogen (H), methyl, ethyl, n-propyl, iso-propyl, n-butyl, tert.-butyl, n-pentyl and phenyl. More preferably, R¹ and R² are the same or different and are chosen from the group of substituents consisting of H, methyl and ethyl.

Also preferably R³ is chosen from the group consisting of methylene, ethylene, n-propylene, iso-propylene, n-butylene, tert.-butylene, n-pentylene, n- octylene, n-dodecylene, phenylene and naphthylene.

Highly preferably, the metal phosphinate comprises a hypophosphate and/or a C₁-C₂ dialkylphosphinate, more preferably Ca-hypophosphate and/or an Al—C₁-C₂ dialkylphosphinate, i.e. Al-dimethylphosphinate, Al-methylethylphosphinate and/or Al-diethylphosphinate. The best results are obtained if Al-diethylphosphinate is used.

### D. Nitrogen Containing and Nitrogen/Phosphor Containing Flame Retardant

The nitrogen containing and nitrogen/phosphor containing component D in the flame retardant elastomeric copolymer composition can be any nitrogen or nitrogen and phosphor containing compound that itself is a flame retardant and/or is a flame retardant synergist for phosphinate flame retardants. Suitable nitrogen containing and nitrogen/phosphor containing compounds that can be used as component D are described, for example in PCT/EP97/01664, DE-A-197 34 437, DE-A-197 37 72, and DE-A-196 14 424.

Preferably, the nitrogen containing synergist is chosen from the group consisting of benzoguanamine, tris(hydroxyethyl)isocyanurate, allantoine, glycouril, melamine, melamine cyanurate, dicyandiamide, guanidine and carbodiimide, and derivatives thereof.

More preferably, the nitrogen containing synergist comprises a condensations product of melamine. Condensation products of melamine are, for example, melem, melam and melon, as well as higher derivatives and mixtures thereof. Condensations products of melamine can be produced by a method as described, for example, in PCT/WO 96/16948.

Preferably, the nitrogen/phosphor containing flame retardant is a reaction product of melamine with phosphoric acid and/or a condensation product thereof. With the reaction product of melamine with phosphoric acid and/or a condensation product thereof are herein understood compounds, which result from the reaction of melamine or a condensation product of melamine, for example, melem, melam and melon, with a phosphoric acid.

Examples include dimelaminephosphate, dimelamine pyrophosphate, melamine phosphate, melamine polyphosphate, melamine pyrophosphate, melamine polyphosphate, melam polyphosphate, melon polyphosphate and melem polyphosphate, as are described for example in PCT/WO 98/39306. More preferably the nitrogen/phosphor containing flame retardant is melamine polyphosphate.

Preferably the flame retardant component D is melamine cyanurate or melamine polyphosphate. Most preferably the flame retardant component D is melamine cyanurate.

Most preferably the composition according to the invention contains Al-diethylphosphinate as flame retardant component C and melamine cyanurate as flame retardant component D.

### E. Glass Fibers

The composition according to the invention contains preferably 40-80 parts by weight of glass fibers, more preferably 45-75 parts by weight, even more preferably 50-70 parts by weight.

### F. Further Additives

The composition according to the invention, may further contain usual additives, like for example processing aids, pigments, colorants, stabilizers, fillers etc. The composition according to the invention comprises preferably less than 10 parts by weight of further organic additives, more preferably less than 5 parts by weight, more preferably less than 2 parts by weight, most preferably less than 1 part by weight.

Preferably the composition according to the invention exists of components A-F.

The invention is further explained by hands of the examples, without being restricted thereto.

### Materials

PBT1: PBT 1060, a PBT delivered by DSM in the Netherlands.

PBT2: PBT 5007, a PBT delivered by DSM in the Netherlands.

PET: BAGA 5018, PET delivered by DSM in the Netherlands.

Glass fibers: CPIC ECS 303A glass fibers delivered by CPIC in China.

DEPAL: Exolit OP 1230, Aluminium Diethylphosphinate, delivered by Clariant, in Germany.

Mecy: Sechuan Mecy powder, melamine cyanurate powder delivered by Sechuan in China.

Melapur 200/70: melamine polyphosphate, delivered by Ciba in Switzerland.

### Compounding

Moulding compositions were prepared by melt-blending the PBT and PBT/PET with the flame retardant components, glass fibers and a usual package of stabilisers on a ZSK 25/33 twin-screw extruder with screw speed 400 rpm, throughput of 25 kg/hr, and melt temperature regulated at 270° C. The glass fibers were added at a side feed opening about half way the extruder barrel. The melt from the extruder is transported through a granulation die. The granules obtained by compounding in the extruder were dried for 24 hours at 90° C., prior to further use.

### Moulding of Test Samples

Test samples for testing the mechanical properties and the flame retardancy properties according to UL-94-V were prepared on an injection-moulding machine of type Engel 80 A. For the injection moulding set temperatures of 250-265° C. were used. The mould temperature was 90° C.

Properties measured on the samples:
MVR (280° C./2.16 kg): Melt Volume Rate at a temperature of 280° C., under a weight of 2.16 kg according to ISO 1133.
TM, TS, E.a.b.: tensile modulus, tensile strength and elongation at break according to ISO 527-1A.
CharpyN: impact resistance by notched Charpy according to ISO 179/1eA.
CharpyUN: impact resistance by unnotched Charpy according to ISO 179/1eU.
UL94V (0.4mm;48h): flame retardancy according to UL94V test, at a sample thickness of 0.4 mm and a precondition of the sample during 48 hours at 23° C. and 50% relative humidity. Measured was the burning time (total afterflame times t1+t2 of 5 specimen), the time that the sample kept burning after ignition.
GWIT-Glow wire ignition temperature according to IEC 60695-2-13.
Gloss: the gloss was determined visually.

### EXAMPLES 1, 2 AND COMPARATIVE EXPERIMENT A, B

Compounds with the compositions of Examples 1 and 2 and according to the invention and Comparative Experiments A and B were prepared and tested as described above. The compositions and test results are presented in Tables 1 and 2.

TABLE 1

| | Comp. | Comp. | | |
|---|---|---|---|---|
| Component | Ex. A | Ex. B | Exp. 1 | Exp. 2 |
| PBT1 | 49.75% | 0.00% | 29.75% | 29.75% |
| PBT2 | 0.00% | 49.75% | 0.00% | 0.00% |
| PET | 0.00% | 0.00% | 19.90% | 19.90% |
| Glass fibers | 30.00% | 30.00% | 30.00% | 30.00% |
| DEPAL | 13.30% | 13.30% | 13.30% | 13.30% |
| Mecy | 0.00% | 0.00% | 0.00% | 6.70% |
| Melaminepolyphosphate | 6.70% | 6.70% | 6.70% | 0.00% |

TABLE 2

| | | Comp. Ex. | Comp. Ex. | | |
|---|---|---|---|---|---|
| Property | Unit | A | B | Exp. 1 | Exp. 2 |
| MVR | (dg/min) | 24 | 16 | 18 | 17 |
| (280° C./2.16 kg) | | | | | |
| TM | (MPa) | 11679 | 11704 | 12368 | 12167 |
| TS | (MPa) | 98.27 | 99.71 | 100.48 | 101.01 |
| E.a.b. | (%) | 1.8 | 2.0 | 1.5 | 1.6 |
| CharpN | (kJ/m2) | 6.0 | 6.1 | 5.6 | 5.6 |
| Charpy UN | (kJ/m2) | 30.7 | 32.4 | 29.8 | 28.9 |
| Density | (g/cc) | 1.569 | 1.573 | 1.585 | 1.580 |
| Total afterflame | (sec) | 31.5 | 28.7 | 20.2 | 18.4 |
| time in UL94V | | | | | |
| (0.4 mm; 48 h) | | | | | |
| GWIT(0.8 mm) | (° C.) | 775 | 775 | 800 | 800 |
| Gloss | — | fair | fair | good | Good |

The samples according to the invention show improved burning times and higher gloss. Also the GWIT shows improved values.

1. Polymer composition containing:
as the polymeric constituents
A. 90-50 wt. % polybutylene terephthalate (PBT)
B. 10-50 wt. % polyethylene terephthalate (PET),
the polymeric constituents add up to 100 wt. %,
at 100 part by weight of the sum of the polymeric constituents:
C. 10-40 part by weight of metal salts of phosphinic acids and/or diphosphinic acids or polymeric derivatives thereof.
D. 3-30 part by weight of a nitrogen or nitrogen and phosphor containing flame retardant synergist for metal salts of phosphinic acids and/or diphosphinic acids or polymeric derivatives thereof,
E. 0-80 part of glass fibers.

2. Composition according to claim 1, the composition shows a burning time of less than 25 sec for a sample having a thickness of 0.4 mm.

3. Composition according to claim 1, wherein the composition contains 80-52 wt. % PBT and 20-48 wt. % PET.

4. Composition according to claim 1, wherein the composition contains 40-80 wt. % of glass fibers.

5. Composition according to claim 1, wherein the composition contains 20-30 parts by weight of metal salts of phosphinic acids and/or diphosphinic acids or polymeric derivatives thereof.

6. Composition according to claim 1, wherein the composition contains 8-20 part by weight of a nitrogen or nitrogen and phosphor containing flame retardant synergist for metal salts of phosphinic acids and/or diphosphinic acids or polymeric derivatives thereof.

7. Composition according to claim 1, wherein component C is Al-diethylphosphinate.

8. Composition according to claim 1, wherein component D is melamine cyanurate.

9. Composition according to claim 1, which composition consists of components A, B, C, D, E and F, where component F is one or more of the usual additives.

10. Objects produced from the composition according to claim 1.
